(19) United States
(12) Patent Application Publication
(10) Pub. No.: US 2026/0095272 A1
(43) Pub. Date: Apr. 2, 2026

(54) AUTOMATIC DISCOVERY MAXIMUM TRANSMISSION UNIT ADJUSTMENT

(71) Applicant: Fortinet, Inc., Sunnyvale, CA (US)

(72) Inventors: Sebastiano Troia, Rome (IT); Diego Bernardelli, Sophia (FR)

(73) Assignee: Fortinet, Inc., Sunnyvale, CA (US)

(21) Appl. No.: 18/904,540

(22) Filed: Oct. 2, 2024

(51) Int. Cl. H04L 1/00

(52) U.S. Cl. CPC H04L 1/0005; H04L 1/0061

(57) ABSTRACT

Automatically discovering a maximum transmission unit (MTU) includes sending, by a first computing system, a first plurality of test packets over at least one path in a network to a second computing system; receiving, by the first computing system, a second plurality of response packets to the first plurality of test packets over the network from the second computing system; determining, based at least in part on the first plurality of test packets and the second plurality of response packets, whether a mismatch exists between a network transmission media MTU of the first computing system and a discovered path MTU of the at least one path; in response to a mismatch existing, taking a remediation action; and repeating the sending, receiving, determining and reducing until no mismatch exists.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Various embodiments of the present disclosure generally relate to computer networks and computing systems. In particular, embodiments relate to automatically adjusting a maximum transmission unit setting for processing of packets in a computer network.

In computer networking, the maximum transmission unit (MTU) is the size of the largest protocol data unit (PDU) that can be communicated in a single network layer transaction. The MTU relates to, but is not identical to, the maximum frame size that can be transported on the data link layer (e.g., Ethernet frame). MTUs apply to communications protocols and network layers. The MTU is specified in terms of bytes or octets of the largest PDU that the layer can pass onwards. A larger MTU is associated with reduced overhead, but smaller MTU values can reduce network delay. In many cases, the MTU is dependent on underlying network capabilities and must be adjusted manually or automatically to not exceed these capabilities. Standards (for example, Ethernet) can define the size of an MTU, or systems may decide MTU at connect time. In some computer networks using tunnels, different devices of the networks may have different MTUs for tunnels in various scenarios. This may cause problems when the MTU of the tunnel is higher than the MTU of a device in the network supporting the tunnel.

### SUMMARY

Systems and methods are described for improving packet processing technology in the context of computer networking and cloud computing. The present disclosure describes methods for automatically adjusting the MTU of a network device, wherein the MTU is the maximum length in bytes of a packet transmitted over a physical or virtual network device interface. An embodiment periodically runs a path MTU health check to ensure that the network device transmission media MTU is consistent with a path MTU in the network. An embodiment may send a notification if the status from the MTU health check changes. An embodiment automatically adjusts the network device transmission media MTU if a change in the path MTU has been discovered or if a path has been locally invalidated.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a first computer networking environment according to an embodiment of the present disclosure.

FIG. 2 illustrates a second computer networking environment according to an embodiment of the present disclosure.

FIG. 3 illustrates automatic discovery MTU adjustment processing according to an embodiment of the present disclosure.

FIG. 4 illustrates automatic discovery MTU adjustment processing according to an embodiment of the present disclosure.

FIG. 5 illustrates automatic discovery MTU adjustment processing according to an embodiment of the present disclosure.

FIG. 6 illustrates automatic discovery MTU adjustment processing according to an embodiment of the present disclosure.

FIG. 7 illustrates an example computing system in which or with which embodiments of the present disclosure may be utilized.

### DETAILED DESCRIPTION

Embodiments of the technology disclosed herein improve the processing of packets in a computer networking environment by automatically adjusting the MTU in a network path as needed.

In the following description, numerous specific details are set forth to provide a thorough understanding of embodiments of the present disclosure. It will be apparent, however, to one skilled in the art that embodiments of the present disclosure may be practiced without some of these specific details. In other instances, well-known structures and devices are shown in block diagram form.

Brief definitions of terms used throughout this application are given below.

A “computer”, “computer system” or “computing system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” or a “computing system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform one or more network functions. Other network devices may also include custom hardware (e.g., one or more custom (ASICs)). Based upon the disclosure provided herein, one of ordinary skill in the art will recognize a variety of network appliances that may be used in relation to different embodiments.

As used herein, the phrases “network path”, “communication path”, or “network communication path” generally refer to a path whereby information may be sent from one end and received on the other. In some embodiments, such paths are referred to commonly as tunnels which are configured and provisioned as is known in the art. Such paths may traverse, but are not limited to traversing, wired or wireless communication links, wide area network (WAN) communication links, local area network (LAN) communication links, and/or combinations of the aforementioned. Based upon the disclosure provided herein, one of ordinary skill in the art will recognize a variety of communication paths and/or combinations of communication paths that may be used in relation to different embodiments.

The phrases “processing resource” and “processing circuitry” are used in their broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

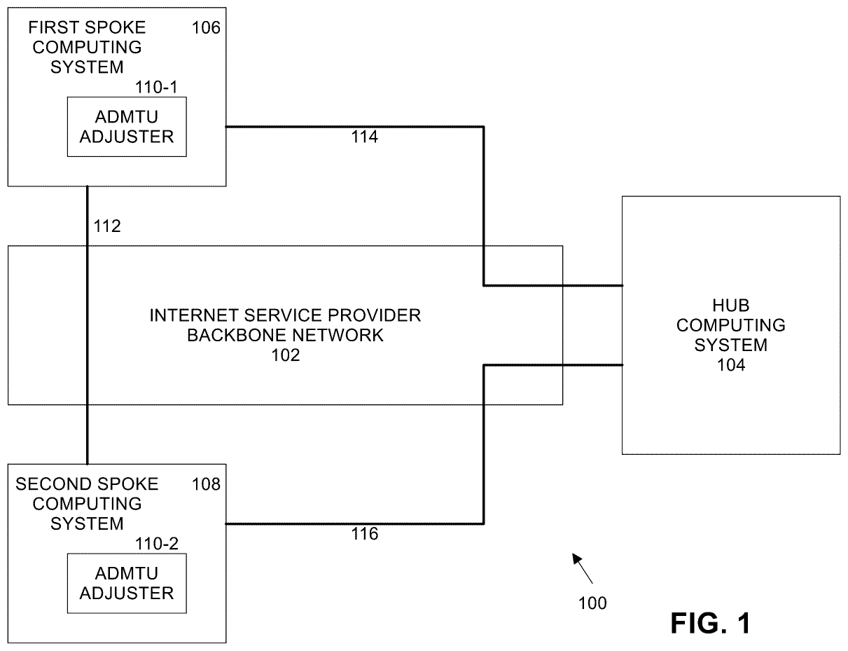

FIG. 1 illustrates a first computer networking environment according to an embodiment of the present disclosure. First computer networking environment 100 exemplifies a hub and spoke architecture, wherein a hub computing system may be coupled over a computer network to a plurality of spoke computing systems. In this example, hub computing system 104 (e.g., a computer server such as a cloud computing environment server) may be coupled by Internet service provider (ISP) backbone network 102 to at least two spoke computing systems, such as first spoke computing system 106 and second spoke computing system 108. In this example, first spoke computing system 106 is coupled using first tunnel 114 to hub computing system 104, second spoke computing system 108 is coupled to hub computing system 104 using second tunnel 116, and first computing system 106 is coupled to second spoke computing system 108 using third tunnel 112, where a tunnel (such as a virtual private networking (VPN) tunnel passing through the ISP backbone network 102 (often using IP security (IPsec) as a VPN tunnel technology)) may be used to discretely transmit data across an otherwise public network. Thus, first spoke computing system 106 may securely send packets to hub computing system 104 using first tunnel 114, second spoke computing system 108 may securely send packets to hub computing system 104 using second tunnel 116, and first and second spoke computing systems may securely exchange packets using third tunnel 112. Although only one hub computing system and two spoke computing systems are shown in the simple example of FIG. 1, it should be understood that first computer networking environment 100 may include any number of hub computing systems and spoke computing systems.

In an embodiment, first computing network environment 100 may comprise a software-defined wide area network (SD-WAN), hub computing system 104 may be a SD-WAN hub with static tunnels configured with each spoke computing system, and first and second spoke computing systems may be SD-WAN spokes with static tunnels with each hub and temporary tunnels with other spoke computing systems.

In an embodiment, each spoke computing system includes an automated discovery maximum transmission unit (ADMTU) adjuster 110. ADMTU adjuster 110 may automatically discover and adjust the MTU for an interface (e.g., either physical or virtual) of a network device on a network interface. An ADMTU adjuster monitors packet processing in first computing networking environment 100 and automatically adjusts the MTU of packets sent by a spoke computing system as needed. An instance of an ADMTU adjuster may be executed in each spoke computing system, such as ADMTU adjuster 110-1 in first spoke computing system 106 and ADMTU adjuster 110-2 in second spoke computing system 108.

Generally, during a health check of packet processing paths through ISP backbone network 102, ADMTU adjuster 110 may send a plurality of packets (called echo requests herein) with adaptively determined MTU sizes from a spoke computing system to hub computing system 104. An echo request may be sent by a sender (e.g., spoke computing system) to determine if a network device (e.g., hub computing system 104) is reachable with an Internet Protocol (IP) address configured in an echo request destination IP field of a test packet. In response, hub computing system 104 sends a plurality of responses (called echo replies herein). The ADMTU adjuster analyzes the responses and determines if the path MTU (e.g., through ISP backbone network 102) should be adjusted. If so, the ADMTU adjuster automatically adjusts the network device transmission media MTU (that is, the MTU of the sending network device (e.g., spoke computing system)). This process may be repeated periodically or according to some other basis to continually adjust the MTU to improve overall network performance.

ISP backbone network 102 may be any type of communication network known in the art. Those skilled in the art will appreciate that ISP backbone network 102 may be wireless network, a wired network, or a combination thereof that can be implemented as one of the various types of networks, such as an Intranet, a Local Area Network (LAN), a Wide Area Network (WAN), an Internet, and the like. Further, ISP backbone network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. In an embodiment, ISP backbone network 102 may be a very large aggregation of many network devices such as routers, switches, firewalls, etc., to provide Internet service to a large number of customers.

In an embodiment, ADMTU adjuster 110 may be included in an operating system (OS) (such as FortiOS available from Fortinet, Inc.) or network security appliance (NSA) or may be a standalone software or hardware module in a spoke computing system. For example, ADMTU adjuster 110 may be included in any virtual machine that performs processing of data for security and/or computer networking purposes. Such purposes may include, but are not limited to, authentication, next-generation firewall protection, anti-trojan scanning, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Security (IPSec), TLS, SSL), application control, Voice over Internet Protocol (VOIP) support, Virtual Private Networking (VPN), data leak prevention (DLP), antispam, antispyware, logging, reputation-based protections, event correlation, network access control, vulnerability management, and the like. Based upon the disclosure provided herein, one of ordinary skill in the art will recognize a variety of MTU adjustment processes that may be implemented in accordance with different embodiments. In some embodiments, ADMTU adjuster 110 may be a virtual implementation of a known network security appliance including, but not limited to, network gateways, virtual private network (VPN) appliances/gateways, unified threat management (UTM) appliances (e.g., the FORTIGATE family of network security appliances available from Fortinet, Inc.), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDoS family of DoS attack detection and mitigation appliances).

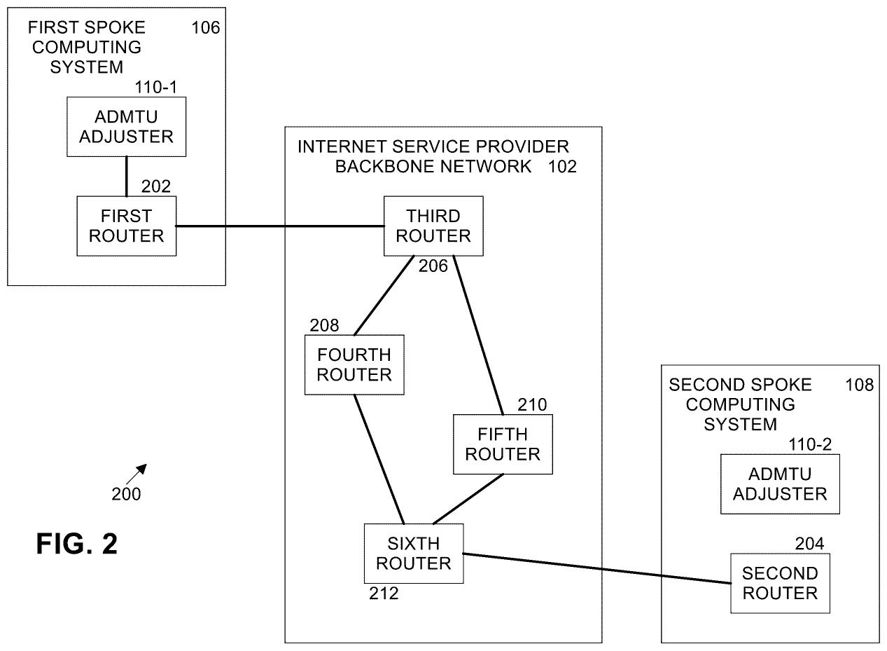

FIG. 2 illustrates a second computer networking environment according to an embodiment of the present disclosure. Second computer networking environment 200 exemplifies spoke-to-spoke communication between first spoke computing system 106 and second spoke computing system 108. In this example, first computing system 106 includes first router 202 to communicate with ISP backbone network 102 and second spoke computing system 108 includes second router 204 to communicate with ISP backbone network 102. By using ISP backbone network 102, a packet sent by first router 202 to second router 204 may be forwarded by one or more intermediate routers in the ISP backbone network. For example, a packet sent by first router 202 to second router 204 may take a first path through third router 206 to fourth router 208 to sixth router 212 to second router 204. In another example, a packet sent by first router 202 to second router 204 may take a second path through third router 206 to fifth router 210 to sixth router 212 to second router 204. In a further example, a packet sent by first router 202 to second router 204 may be divided into fragments, where one or more fragments follow the first path and one or more fragments follow the second path, or all fragments follow the first path or the second path.

However, problems (e.g., lost packets, etc.) may arise in second computer networking environment 200, for example, when the MTU of any of the third, fourth, fifth and sixth routers (known as path MTUs herein) are lower than the MTU of first router 202 (also known as network transmission media MTU herein).

Similar to the processing described above for first computer networking environment 100, during a health check of packet processing paths through ISP backbone network 102, ADMTU adjuster 110-1 in first spoke computing system 106 may send a plurality of echo request packets with adaptively determined MTU sizes to second spoke computing system 108. In response, second spoke computing system 108 sends a plurality of echo replies. In an embodiment, the echo requests and echo replies conform to the Internet Control Message Protocol (ICMP), a Layer 3 Internal Standards Organization (ISO) Network Model Protocol used to test network reachability of devices having an IP address. ADMTU adjuster 110-1 analyzes the responses, determines a maximum MTU common to all the interfaces of network devices interfaces along a path of packet delivery and determines if the local network device transmission media MTU should be adjusted. If so, the ADMTU adjuster automatically adjusts the network device transmission media MTU (that is, the MTU of first router 202). This process may be repeated periodically, or according to some other basis, to continually adjust the MTU to improve overall network performance.

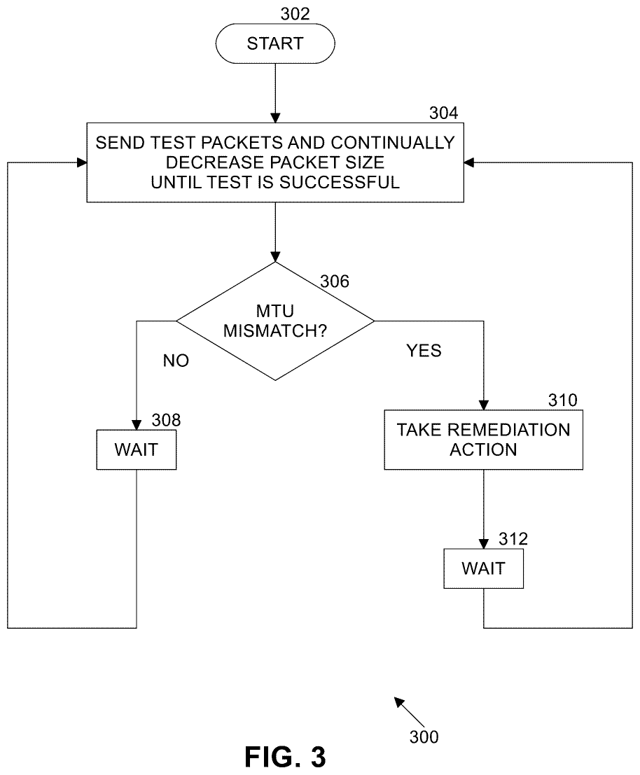

FIG. 3 illustrates automatic discovery MTU adjustment processing 300 according to an embodiment of the present disclosure. In the embodiment shown in flow 300, ADMTU adjuster 110 at block 304 sends a plurality of test packets (e.g., echo requests), analyzes the responses (e.g., echo replies), and continually decreases the packet size (e.g., corresponding to a lower path MTU) of test packets until the test is successful. In an example, ten test packets may be sent, with five test packets (e.g., a first portion) having a “don't fragment” (DF) bit set (e.g., set to one) in a flag field of the packet header and five test packets (e.g., a second portion) having a DF bit not set (e.g., set to zero) in the flag field of the packet header. In another example, other numbers of test packets may be sent, with any number having the DF bit set and any number having the DF bit not set. At block 306, ADMTU adjuster 110 determines if there is a mismatch between the network transmission media MTU (e.g., of first router 202) and the discovered path MTU (e.g., the lowest MTU of routers along the path in ISP backbone network 102, such as third router 206, fourth router 208, fifth router 210, and sixth router 212). If there is no mismatch of MTUs, then at block 308 ADMTU adjuster 110 may wait a predetermined amount of time before continuing with the health check again at block 304. If there is a mismatch of MTUs, at block 310 ADMTU adjuster may direct that one or more remediation actions should be taken. In an embodiment, remediation action may include reducing a local link MTU setting (e.g., reducing the network transmission media MTU of first router 202), invalidating the local link (e.g., invalidating the tunnel 112 between first spoke computing system 106 and second spoke computing system 108), and notifying a system administrator of first or second computer networking environments. In other embodiments, other remediation actions may be taken. After one or more remediation actions are taken, at block 312 ADMTU adjuster 110 may wait a predetermined amount of time before continuing with the health check again at block 304.

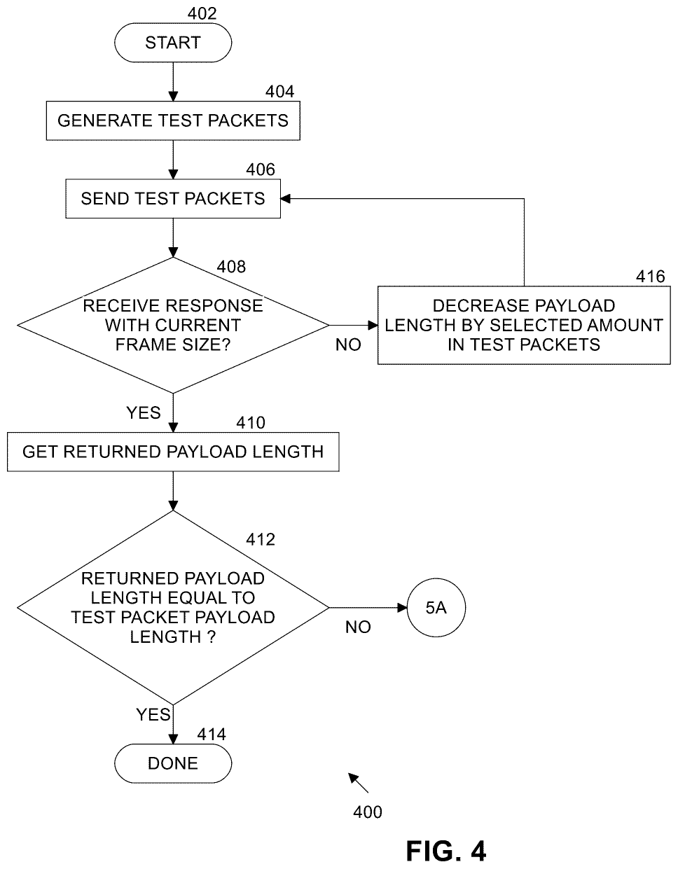

FIG. 4 illustrates automatic discovery MTU adjustment processing 400 according to an embodiment of the present disclosure. After block 402, ADMTU adjuster 110 generates a plurality of text packets with a payload at block 404. For example, half of the test packets may have the DF bit set to one and half of the test packets may have the DF bit not set. In each test packet, ADMTU adjuster 110 sets the frame size (e.g., corresponding to the MTU (the packet size is equal to the Ethernet header length plus the IP header length plus the ICMP header length plus the ICMP payload size) to 100% of the MTU of the selected network interface (e.g., the network interface under test). In an embodiment, the initial payload length is equal to the network transmission media MTU minus the ICMP header length minus the IP header length minus the Ethernet header length. At block 406, ADMTU adjuster 110 sends the test packets over the selected network interface to ISP backbone network 102. ADMTU adjuster 110 then waits until one or more responses are received from the network device receiving the test packets (such as hub computing system 104). At block 408, ADAMTU adjuster compares frame sizes and if ADMTU adjuster 110 receives at least one response with the current frame size (e.g., initially this is 100% of the network device transmission media MTU), then ADMTU adjuster 110 gets the payload of the response packet. At block 412, if the payload length of the response packet is equal to the (initial) payload length of the test packet, then health check processing is complete at block 414 with a successful status and no remediation actions being taken. At block 408, if ADMTU adjuster 110 does not receive at least one response with the current frame size, then ADMTU adjuster 110 decreases the payload length in test packets by a selected amount (for example, by 1%, 2%, 4%, 5% or another suitable amount). ADMTU adjuster processing then continues with sending the test packets with the adjusted payload length at block 404.

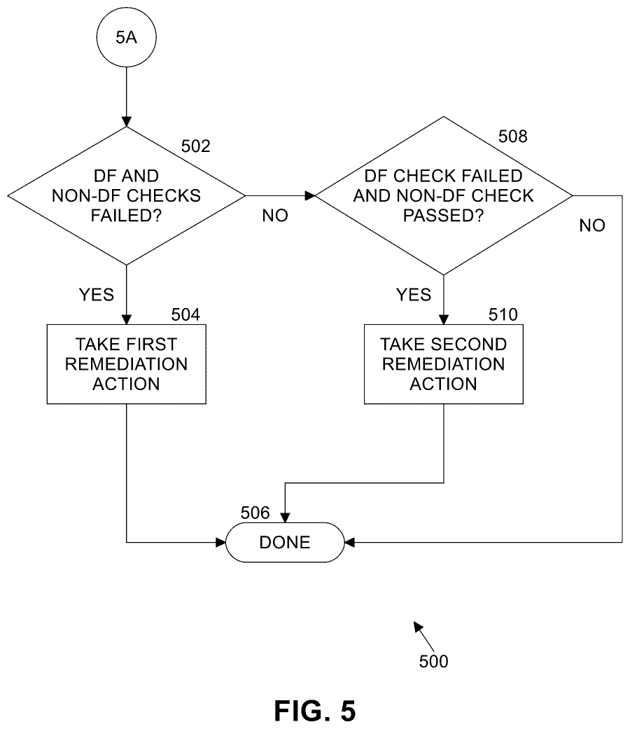

At block 412, if the payload length of a response packet is not equal to the initial payload length of the test packet, then processing continues via connector 5A to block 502 of FIG. 5.

FIG. 5 illustrates automatic discovery MTU adjustment processing 500 according to an embodiment of the present disclosure. At block 502, ADMTU adjuster 110 determines if all sent test packets having DF bits set and all sent test packets having DF bits not set have failed (that is, no test packet is returned over the selected network interface from the targeted network device). If so, this is an error condition and ADMTU adjuster 110 may take, or cause the spoke computing system to take, a first remediation action at block 504, and health check processing is done at block 506. In an embodiment, the first remediation action may include one or more of: a) notify only-send a notification to the administrator via email, simple network management protocol (SNMP) or system log (syslog); b) invalidate the path-disable the local network transmission media if the MTU mismatch is found in the path; and c) adjust the MTU-change the local transmission media MTU according to the maximum MTU discovered on the path.

If not all sent test packets having DF bits set and all sent test packets having DF bits not set have failed at block 502 (e.g., indicating at least one response packet has been received), then at block 508 ADMTU adjuster 110 determines if at least one response packet with the DF bit not set has been received and no test packets with the DF bit set have been received (e.g., suggesting that fragmentation of the test packets during communication over ISP backbone network 102 may have been an issue). If so, ADMTU adjuster 110 may take, or cause the spoke computing system to take, a second remediation action at block 510, and health check processing is done at block 506. In an embodiment, the second remediation action may include one or more of: a) notify only-send a notification to the administrator via email, simple network management protocol (SNMP) or system log (syslog); b) invalidate the path-disable the local network transmission media if the MTU mismatch is found in the path; and c) adjust the MTU-change the local transmission media MTU according to the maximum MTU discovered on the path.

If not, ADMTU adjuster 110 takes no remediation action and health check processing is done at block 506 (however, this outcome should not occur). The processing described in FIGS. 4 and 5 may be repeated periodically or based at least in part on a predetermined condition.

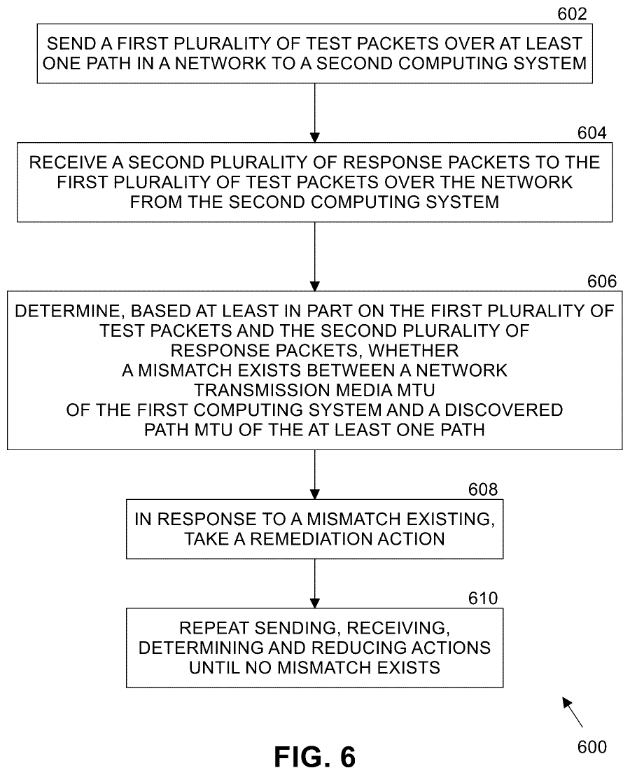

FIG. 6 illustrates automatic discovery MTU adjustment processing 600 according to an embodiment of the present disclosure. In an embodiment, FIG. 6 illustrates processing performed by ADMTU adjuster 110. At block 602, an ADMTU adjuster of a first computing system sends a first plurality of test packets over at least one path in a network to a second computing system. At block 604, the ADMTU adjuster receives a second plurality of response packets to the first plurality of test packets over the network from the second computing system. At block 606, the ADMTU adjuster determines, based at least in part on the first plurality of test packets and the second plurality of response packets, whether a mismatch exists between a network transmission media maximum transmission unit of the first computing system and a discovered path maximum transmission unit of the at least one path. At block 608, in response to a mismatch existing, the ADMTU adjuster takes a remediation action. At block 610, the ADMTU adjuster repeats the sending, receiving, determining and reducing until no mismatch exists.

An example of pseudocode for an implementation of ADMTU adjuster 110 processing is shown in Table 1.

TABLE 1
--------------------------------------------------------------------------------------------
© 2024 Fortinet, Inc.
Function: main( )
Expected parameters: none
Variables: admtuHCResult → array containing the result of function “admtuHCinit( )”
Function: admtuHCinit( )
Expected parameters: ipv4Target, nitMtu, nic
Expected parameters explanation:
Ipv4Target →target ip addressto reach for testing
nicMtu →mtuof the localnic to test
nic→ the local interface to test
Variables:
dfSetCheck → boolean state of the check done with DF bit set
dfNotSetCheck → boolean state of the check done with DF bit NOT set
loadString → crafted string used to create the probe payload in the packets
lastPassedPayloadLenDF → variable containing the discovered MTU with function
“prober( )”with DF bit set
lastPassedPayloadLenNoDF → variable containing the discovered MTU with function
“prober( )”with DF bit NOT set
Tasks:
Creating the packets to be sent with and without DF bit set, wait for the result of “prober( )”
and return the outcome to “main( )”.
An MTU mismatch is found if returned payload length from “prober( )” is different from the
initial payload length.
Function:prober( )
Expected parameters: packet → scapy packet created in “admtuHCinit( )”
Variables: reply, decreaseFactor, newPayloadLen,newPayload
Variables explanation:
reply → icmp reply collected by scapy(sent with scapy sr1module)
decreaseFactor →2% reduction of the payload length --> used when the probe is failing
newPayloadLen →newly calculated payload length after reduction
newPayload→ newly created payload
Tasks:
Recursive function, sending 5 times (with scapy sr1) the packet.
Recursive function behavior: If there is no ICMP reply, the payload length is reduced by 2%
(up to 500 bytes length) and “prober( )” is re-called with the updated packet;
else the packet payload length is returned.
----------------------------------------------------------------------------------------

The technology of the packet processing system described herein provides at least several advantages and technical improvements over existing computer networking systems. Embodiments avoid packet loss introduced by network devices in the path due to lower MTUs than the local network device transmission media MTU. Embodiments avoid fragmentation for applications which may be sensitive to fragmentation (e.g., user datagram protocol (UDP)-based applications, voice over Internet protocol (VOIP), control and provisioning of wireless access points (CAPWAP), etc.). Embodiments improve the user experience by reducing potential network disruptions or performance degradations and improve system administration awareness by notifying the system administrator if the MTU changes within the path.

While in the context of the example described with reference to the flow diagrams of this disclosure, a number of enumerated blocks are included, it is to be understood that examples may include additional blocks before, after, and/or in between the enumerated blocks. Similarly, in some examples, one or more of the enumerated blocks may be omitted and/or performed in a different order.

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a tangible non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or general-purpose computer hardware to execute the code contained therein. An apparatus for practicing various embodiments of the present disclosure may involve one or more computer systems (e.g., physical and/or virtual servers, physical and/or virtual network security appliances) (or one or more processors within a single computer system) and storage systems containing or having network access to computer program(s) coded in accordance with various methods described herein, and the method steps associated with embodiments of the present disclosure may be accomplished by modules, routines, subroutines, or subparts of a computer program product.

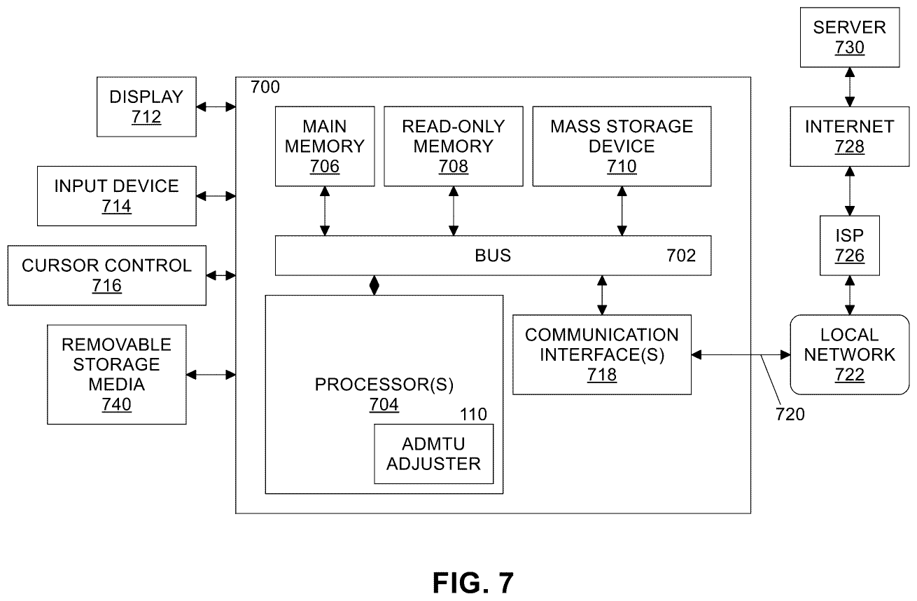

FIG. 7 illustrates an example computing system in which or with which embodiments of the present disclosure may be utilized. In an embodiment, computing system 700 is an example of first spoke computing system 106 and/or second spoke computing system 108. FIG. 7 shows a block diagram that illustrates a computing system 700 in which or with which an embodiment of the present disclosure may be implemented. Computing system 700 may be representative of a computer server (e.g., a cloud server in a cloud computing environment) or client computing system on which ADMTU adjuster 110 is running. Notably, components of computing system 700 described herein are meant only to exemplify various possibilities. In no way should the example computing system 700 limit the scope of the present disclosure. In the context of the present example, computing system 700 includes a bus 702 or other communication mechanism for communicating information, and one or more processing resources (e.g., one or more hardware processors 704) coupled with bus 702 for processing information. Hardware processors 704 may include, for example, one or more general purpose microprocessors available from one or more current or future microprocessor manufactures (e.g., Intel Corporation, Advanced Micro Devices, Inc., and/or the like) and/or one or more special purpose processors (e.g., graphics processing units (GPUs), network processors (NPs), and/or accelerators or co-processors). In some examples, one or more processing resources may be part of an application specific integrated circuit (ASIC)-based security processing unit (e.g., the FORTISP family of security processing units available from Fortinet, Inc. of Sunnyvale, CA).

Computing system 700 also includes a main memory 706, such as a machine-readable random-access memory (RAM) or other dynamic storage device, coupled to bus 702 for storing information and instructions (e.g., ADMTU adjuster 110) to be executed by processor(s) 704. Main memory 706 also may be used for storing temporary variables or other intermediate information during execution of instructions to be executed by processor(s) 704. Such instructions, when stored in non-transitory storage media accessible to processor(s) 704, render computing system 700 into a special-purpose machine that is customized to perform the operations specified in the instructions.

Computing system 700 further includes a read only memory (ROM) 708 or other static storage device coupled to bus 702 for storing static information and instructions (e.g., ADMTU adjuster 110) for processor(s) 704. A storage device 710, e.g., a magnetic disk, optical disk or flash disk (made of flash memory chips), is provided and coupled to bus 702 for storing information and instructions.

Computing system 700 may be coupled via bus 702 to a display 712, e.g., a cathode ray tube (CRT), Liquid Crystal Display (LCD), Organic Light-Emitting Diode Display (OLED), Digital Light Processing Display (DLP) or the like, for displaying information to a computer user. An input device 714, including alphanumeric and other keys, is coupled to bus 702 for communicating information and command selections to processor(s) 704. Another type of user input device is cursor control 716, such as a mouse, a trackball, a trackpad, or cursor direction keys for communicating direction information and command selections to processor(s) 704 and for controlling cursor movement on display 712. The input device typically has two degrees of freedom in two axes, a first axis (e.g., x) and a second axis (e.g., y), that allows the device to specify positions in a plane.

Removable storage media 740 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computing system 700 may implement the techniques described herein using customized hard-wired logic, one or more ASICs or field programmable gate arrays (FPGAs), firmware or program logic which in combination with the computer system causes or programs computing system 700 to be a special-purpose machine. According to one embodiment, the techniques herein are performed by computing system 700 in response to processor(s) 2004 executing one or more sequences of one or more instructions (e.g., ADMTU adjuster 110) contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “storage media” as used herein refers to any non-transitory machine-readable media that store data or instructions that cause a machine to operate in a specific fashion. Such storage media may comprise non-volatile media or volatile media. Non-volatile media includes, for example, optical, magnetic or flash disks, such as storage device 710. Volatile media includes dynamic memory, such as main memory 706. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor(s) 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor(s) 704 retrieve and execute the instructions. The instructions received by main memory 706 may optionally be stored on storage device 710 either before or after execution by processor(s) 704.

Computing system 700 also includes a communication interface 718 coupled to bus 702. Communication interface 718 provides a two-way data communication coupling to a network link 720 that is connected to a local network 722 (or ISP backbone network 102). For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection to data equipment operated by an Internet Service Provider (ISP) 726. ISP 726 in turn provides data communication services through the world-wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computing system 700, are example forms of transmission media.

Computing system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor(s) 704 as it is received, or stored in storage device 710, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
sending, by a first computing system, a first plurality of test packets over at least one path in a network to a second computing system;
receiving, by the first computing system, a second plurality of response packets to the first plurality of test packets over the network from the second computing system;
determining, based at least in part on the first plurality of test packets and the second plurality of response packets, whether a mismatch exists between a network transmission media maximum transmission unit of the first computing system and a discovered path maximum transmission unit of the at least one path;
in response to a mismatch existing, taking a remediation action; and
repeating the sending, receiving, determining and reducing until no mismatch exists.

2. The method of claim 1, wherein taking the remediation action comprises reducing the network transmission media maximum transmission unit of the first computing system by a predetermined amount.

3. The method of claim 1, wherein taking the remediation action comprises invalidating a tunnel between the first computing system and the second computing system used to send the first plurality of test packets over the network.

4. The method of claim 1, wherein the first plurality of test packets comprises echo requests and the second plurality of response packets comprises echo replies.

5. The method of claim 1, wherein a first portion of the first plurality of test packets include don't fragment (DF) bits set to one in headers of the first plurality of test packets and a second portion of the first plurality of test packets include DF bits set to zero in headers of the first plurality of test packets.

6. The method of claim 1, comprising, in response to no mismatch existing, waiting a predetermined time and repeating the sending, receiving, and determining.

7. The method of claim 1, wherein the network comprises an Internet service provider backbone network, and the first computing system and the second computing system are coupled as a software-defined wide area network (SD-WAN) over the Internet service provider backbone network.

8. The method of claim 1, comprising determining the mismatch by comparing frame sizes of the second plurality of response packets to a current frame size of the first plurality of test packets.

9. The method of claim 1, comprising determining the mismatch by comparing payload lengths of the second plurality of response packets to payload lengths of the first plurality of test packets.

10. A non-transitory, machine-readable medium storing instructions, which when executed by one or more processing resources, cause the one or more processing resources to:
send, by a first computing system, a first plurality of test packets over at least one path in a network to a second computing system;
receive, by the first computing system, a second plurality of response packets to the first plurality of test packets over the network from the second computing system;
determine, based at least in part on the first plurality of test packets and the second plurality of response packets, whether a mismatch exists between a network transmission media maximum transmission unit of the first computing system and a discovered path maximum transmission unit of the at least one path;
in response to a mismatch existing, take a remediation action; and
repeating the sending, receiving, determining and reducing until no mismatch exists.

11. The non-transitory, machine-readable medium of claim 10, wherein instructions to take the remediation action comprise instructions to reduce the network transmission media maximum transmission unit of the first computing system by a predetermined amount.

12. The non-transitory, machine-readable medium of claim 10, wherein instructions to take the remediation action comprise instructions to invalidating a tunnel between the first computing system and the second computing system used to send the first plurality of test packets over the network.

13. The non-transitory, machine-readable medium of claim 10, wherein a first portion of the first plurality of test packets include don't fragment (DF) bits set to one in headers of the first plurality of test packets and a second portion of the first plurality of test packets include DF bits set to zero in headers of the first plurality of test packets.

14. An apparatus comprising:
processing circuitry; and
instructions that when executed by the processing circuitry cause the apparatus to:
send, by a first computing system, a first plurality of test packets over at least one path in a network to a second computing system;
receive, by the first computing system, a second plurality of response packets to the first plurality of test packets over the network from the second computing system;
determine, based at least in part on the first plurality of test packets and the second plurality of response packets, whether a mismatch exists between a network transmission media maximum transmission unit of the first computing system and a discovered path maximum transmission unit of the at least one path;
in response to a mismatch existing, take a remediation action; and
repeating the sending, receiving, determining and reducing until no mismatch exists.

15. The apparatus of claim 14, wherein the network comprises an Internet service provider backbone network, and the first computing system comprises a first spoke computing system and the second computing system comprises a hub computing system of a software-defined wide area network (SD-WAN) operating over the Internet service provider backbone network.

16. The apparatus of claim 14, wherein the network comprises an Internet service provider backbone network, and the first computing system comprises a first spoke computing system and the second computing system comprises a second spoke computing system of a software-defined wide area network (SD-WAN) operating over the Internet service provider backbone network.

17. The apparatus of claim 14, wherein taking the remediation action comprises reducing the network transmission media maximum transmission unit of the first computing system by a predetermined amount.

18. The apparatus of claim 14, wherein taking the remediation action comprises invalidating a tunnel between the first computing system and the second computing system used to send the first plurality of test packets over the network.

19. The apparatus of claim 14, wherein a first portion of the first plurality of test packets include don't fragment (DF) bits set to one in headers of the first plurality of test packets and a second portion of the first plurality of test packets include DF bits set to zero in headers of the first plurality of test packets.

20. The apparatus of claim 19, comprising instructions that when executed by the processing circuitry cause the apparatus to:
return an error condition in response to all test packets having DF bits set to one and all test packets having DF bits set to zero results in receiving no response packets.
